(19) United States
(12) Patent Application Publication
(10) Pub. No.: US 2020/0317237 A1
(43) Pub. Date: Oct. 8, 2020

(54) ELECTRICAL DEVICE FOR CONNECTION TO A HIGH-VOLTAGE SUPPLY SYSTEM, AND METHOD FOR DETECTING A FAULT OF A COMPONENT OF THE ELECTRICAL DEVICE

(71) Applicant: SIEMENS AKTIENGESELLSCHAFT, MUENCHEN (DE)

(72) Inventors: AIME MBUY, NUERNBERG-WEIHERHAUS (DE); BERTHOLD SEDLMAIER, ROETHENBACH A. D. PEGNITZ (DE); CHRISTIAN SCHUESSEL, ALLERSBERG / GOEGGELSBUCH (DE)

(21) Appl. No.: 16/649,631

(22) PCT Filed: Sep. 14, 2018
(86) PCT No.: PCT/EP2018/074897

§ 371 Date: Mar. 21, 2020

(30) Foreign Application Priority Data
Oct. 2, 2017 (DE) 10 2017 217 530.3

(51) Int. Cl. B61L 15/00; H01F 27/40; H01F 27/12; G01N 29/12; B61L 3/00

(52) U.S. Cl. CPC B61L 15/0081; H01F 27/402; B61L 3/002; G01N 29/12; H01F 27/12

(57) ABSTRACT

An electrical device for connection to a high-voltage supply system includes a fluid-tight tank which is filled with an insulating fluid and in which a core is surrounded by a winding at least in sections. A cooling unit is connected to the tank and a pump circulates the insulating fluid of the tank through the cooling unit. A measuring sensor is provided for detecting vibrations of the pump while providing time-triggered vibration measurement values. A protection unit is connected to the measuring sensor and is configured to receive and convert the time-triggered vibration measurement values into frequency-triggered vibration values. The protection unit analyzes the frequency-triggered vibration values with the aid of a previously determined logic for the existence of a fault criterion and is configured to generate a warning signal in the event that a fault criterion is determined.

The present invention relates to an electrical device for connection to a high-voltage supply system, comprising a fluid-tight tank which is filled with an insulating fluid and in which a core is arranged which is enclosed sectionally by a winding, a cooling unit which is connected to the tank, and a pump for circulating the insulating fluid of the tank via the cooling unit.

The present invention furthermore relates to a method for monitoring a component.

Such an electrical device is known to those skilled in the art from the established practice. Thus, for example, transformers are provided for connection to a high-voltage supply system. If it is designed for high power, a transformer has a fluid-tight tank which is filled with an insulating fluid. An active portion is arranged inside the tank, which is made up of a core and windings which respectively enclose a leg of the core. The insulating fluid is, for example, a mineral oil and is used for insulating the active portion which is at a high voltage potential during operation. In addition, the insulating fluid is used for cooling the active portion. For this purpose, the insulating fluid is circulated by a pump via a cooling unit which is connected to the tank via tubing.

During the course of its service life, the pump is subjected to a wear process. Damage may occur in particular in the ball bearing of the pump. In the case of failure of the pump, the cooling of the transformer also fails. The transformer must therefore be switched off; thus, the energy supply for the loads downstream from the transformer is interrupted. However, this is highly undesirable.

In order to avoid such a failure of the electrical device, currently, the pump is replaced in previously determined maintenance cycles. In particular in the case of a railway transformer, defined maintenance cycles are prescribed in which the different components of the train are simultaneously maintained and possibly replaced in the depot of the rail operator. The replacement of the pump thus takes place before the end of the maximum service life specified by the manufacturer, but not as a function of the actual state of the respective pump. During the operation of the pump, heretofore, there is no check of the actual state of the pump and how long its remaining service life could be.

The object of the present invention is therefore to provide an electrical device and a method of the kind initially specified, via which an unnecessary replacement of a pump can be avoided.

The present invention achieves this object based on the electrical device initially specified, by means of a measuring sensor for detecting the vibrations of the pump while providing time-triggered vibration measurement values, and a protection unit which is connected to the measuring sensor and which is configured for receiving and for converting the time-triggered vibration measurement values into frequency-triggered vibration values, wherein the protection unit analyzes the frequency-triggered vibration values for the existence of a fault criterion with the aid of previously determined logic, and if a fault criterion is determined, said protection unit is configured to generate a warning signal.

Based on the method initially specified, the present invention achieves this object via a method in which vibrations of the component to be monitored are detected while obtaining time-triggered vibration measured values and are transmitted to a protection unit of the electrical device, the protection unit converts the time-triggered vibration measured values into frequency-triggered vibration values, and with the aid of logic, the frequency-triggered vibration values are analyzed for the existence of a fault criterion, wherein the protection unit triggers a warning signal in the case of the existence of a fault criterion.

According to the present invention, the vibrations of a pump or another component of an electrical device are detected by means of a measuring sensor which provides the time-triggered measurement signals on the output side. These time-triggered measurement signals are converted into frequency-triggered measurement signals. This takes place, for example, by means of a Fourier transform which is known to those skilled in the art. The vibration spectra resulting in this manner constitute a so-called fingerprint of the pump or the component, from which the respective status of the pump can be derived.

The protection unit provided according to the present invention has logic on the basis of which it may be detected whether a fault exists. The logic of the protection unit has, for example, information about the frequencies both with respect to their position and with respect to their intensities, which result in the case of a fault-free pump. If the measured spectrum corresponds to the previously known spectrum at least within predefined tolerance values, the protection unit assumes that a repair or possibly a replacement of the pump is unnecessary. However, if, for example, additional frequencies occur or if the identity of the vibrations changes with respect to the fault-free state of the pump, the logic deduces the existence of a fault. In addition, it may indicate which type of faults are concerned. The logic has, for example, a software module which accesses a memory unit in which comparison data in the form of previously known vibration spectra or the like are stored.

According to the present invention, the measuring sensor requires only a small volume, so that it can also be used in applications having limited installation space. The measuring sensor can generally detect the vibrations within the scope of the present invention in any manner. Thus, for example, a simple microphone is sufficient within the scope of the present invention to measure the vibrations in this case via sound waves.

However, in a preferred variant of the present invention, the measuring sensor is directly connected to the protection unit and configured for detecting structure-borne sound. This enables a more compact structure. In addition, the vibrations of the component are directly detected, i.e., without the interposition of an air layer. This increases the accuracy of the measurement. In addition, it is possible to use compact sensors which provide the necessary measurement accuracy in a very small space.

According to an advantageous refinement in this regard, the measuring sensor is an acceleration sensor which is attached to the pump. For example, the measuring sensor is adhesively attached to an outer housing of the pump or the component. In addition, a plurality of measuring sensors or acceleration sensors may be used at different locations on the pump or the component.

According to a refinement of this variant, the measuring sensor is a piezo element. Piezo elements are particularly compact and are economically available on the market.

According to a preferred embodiment of the present invention, the electrical device is a railway transformer. Railway transformers are used with rail vehicles for converting the supply voltage provided by the overhead contact wire. Due to limited installation space, railway transformers must be designed to be as compact as possible. In addition, railway transformers are to be designed to be as light as possible in order not to burden the rail vehicle with more weight than necessary.

Within the scope of the present invention, the railway transformer may be supplemented by a measuring sensor, without the railway transformer thereby exceeding the allowable size or a maximum weight. The measuring sensor according to the present invention is small and can be attached directly to the pump or another component of the railway transformer.

In one variant of the method, the time-triggered vibration measured values or the frequency-triggered vibration values are transmitted via a wireless connection to a cloud server, wherein in addition to the protection unit, the cloud server checks the received data for the existence of a fault criterion with the aid of previously known logic, and in the case of the existence of a fault criterion, generates a cloud warning signal. According to this advantageous refinement, a parallel calculation is carried out in a so-called cloud, i.e., a server, which is supplied with the corresponding measurement data via a wireless connection. Generally, the cloud server having the logic stored in it will achieve the same result as the protection unit of the electrical device. In particular in the case of faults which do not make a rapid switch-off of the pump or the component necessary, it is therefore possible to wait for the arrival of the cloud result. For this purpose, the protection unit waits for the reception of a warning signal from the cloud server, before a warning signal is transmitted. The double check increases the reliability of the method according to the present invention.

Advantageously, the frequency-triggered vibration values are analyzed for the existence of a plurality of fault criteria which are respectively associated with a particular hazard level. As already indicated, the received frequency-triggered spectra constitute a so-called fingerprint of the respective pump. If, for example, a ball of the ball bearing of the pump is damaged, this fault has a characteristic fingerprint. For example, additional frequencies result. Other frequencies have, for example, an increased intensity. The respective logic therefore checks whether the spectrum received via the measurement is similar to a spectrum which is based on a previously known fault. This fault is assigned to a particular hazard category. If, for example, the fault is a minor fault which does not impair the operation of the pump in such a way that it must be switched off immediately, a fault category is assigned which generates a warning signal which generates a yellow warning signal in a display unit which, for example, is attached to the transformer, the electrical device, or a railway vehicle. However, if a serious fault exists which, for example, should result in the failure of the pump or the component in the coming hours or days, a warning signal is generated which triggers a red light in the display element. The personnel can thus deduce the seriousness of the fault based on the displayed signal.

According to a preferred embodiment, the warning signal is transmitted to a display unit which is designed for the optical depiction of the respective fault.

Further advantageous embodiments and advantages of the present invention form the subject matter of the following description of exemplary embodiments of the present invention, with reference to the figures of the drawing, wherein identical reference signs refer to identical components, and wherein

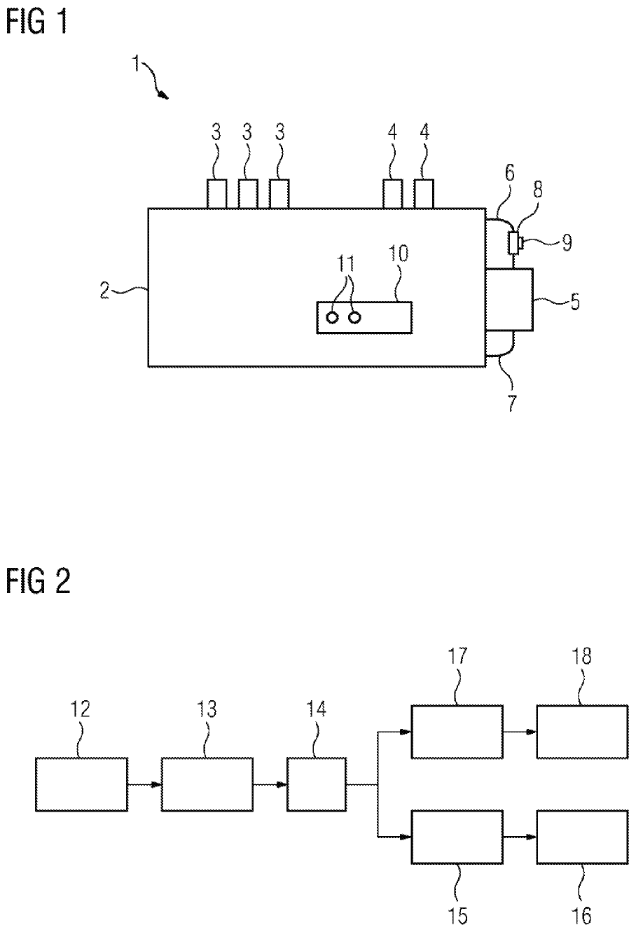

FIG. 1 illustrates a schematic representation of an exemplary embodiment of the electrical device according to the present invention,

FIG. 2 illustrates a schematic representation of the method according to the present invention, and

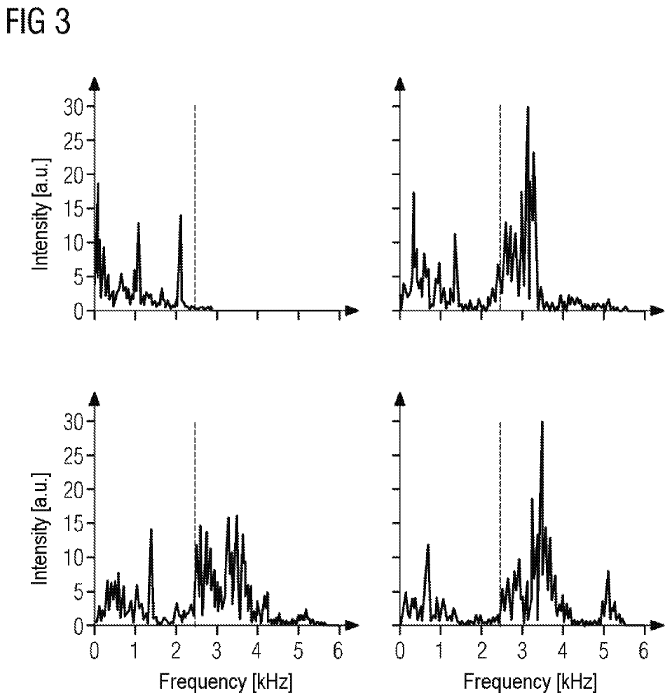

FIG. 3 illustrates characteristic vibration spectra which are received according to the method according to the present invention and the electrical device according to the present invention.

FIG. 1 depicts an exemplary embodiment of the electrical device 1 according to the present invention, which is designed as a railway transformer 1 in the depicted exemplary embodiment. The railway transformer 1 comprises a tank 2 which is designed to be fluid-tight and in which an active portion is arranged which is not visible in the figure. The active portion comprises a core having a leg which is enclosed by two windings which are concentrically arranged with respect to one other. The radially exterior upper-voltage winding is electrically connected to input feedthroughs 3, while the interior winding is connected to two output feedthroughs 4. For insulating the active portion, which is at a high-voltage potential during the operation of the transformer 1 with respect to the tank 2, which is at ground potential, the tank 2 is filled with an insulating fluid, here, an insulating liquid such as ester oil. A cooling unit 5 which is connected to the tank via tubing 6 and 7 is used for cooling. A pump 8 is used for circulating the insulating fluid via the cooling unit 5.

For monitoring the state of the pump 8, said pump is equipped with a measuring sensor 9 which, in the depicted exemplary embodiment, is designed as a piezo element. The piezo element 9 is directly affixed to the housing of the pump 8 and is configured to detect the structure-borne sound of the pump 8. Via a signal line which is not depicted, the piezo element 9 is connected on the output side to a protection unit 10 which is equipped with a display element 11 in the form of a yellow and red illumination unit.

In this case, the piezo element 9 provides time-triggered vibration measured values on the output side which are transmitted to the protection unit 10. The protection unit 10 carries out a Fourier transform of the received data, wherein frequency-triggered vibration values are generated. The depiction of the intensity of the vibrations as a function of the frequencies is referred to here as the vibration spectrum. The detected vibration spectrum is a function of the respective state of the pump 8. In other words, each state of the pump 8 has a resulting so-called fingerprint in the form of a characteristic vibration spectrum. Logic which is stored in the protection unit, for example, software, has access to a data area in which spectra of pumps having previously known faults are stored. The logic compares the measured vibration spectrum with the previously known spectra. If the measured spectrum matches the previously determined comparison spectrum, a comparison spectrum which is based this state of the pump 8 is deduced. In the comparison, typical tolerances are applied.

FIG. 2 shows a schematic sequence of the method according to the present invention; in particular in a first step, a measured value detection 11 by means of the measuring sensor 9 is illustrated. Subsequently, in a step 13, a bandpass filter is used which filters out vibrations which are generated by a fault-free pump 8. In the work step 14, the vibration spectra are monitored for the existence of a fault criterion with the aid of the previously mentioned logic, wherein a hazard level is assigned to the fault. In the case of a less serious fault which does not yet make the immediate replacement necessary, a corresponding warning signal 15 is generated which triggers the illumination of a yellow illumination unit 16 at the display 11. In the case of a serious fault, a warning signal 17 is generated which generates a red signal light 18, whereupon the conductor or the maintenance personnel may effectuate an immediate replacement of the pump.

FIG. 3 depicts typical vibration spectra, wherein on the respective X-axis, the frequency is plotted in kHz, and on the respective Y-axis, the intensity is plotted in arbitrary units (a.u.). In the diagram of FIG. 3 which is depicted on the top left, a vibration spectrum of a fault-free pump is depicted. The dashed line 19 illustrates the action line of the bandpass filter, which suppresses the lower frequencies for the subsequent evaluation unit. In the diagram on the top right, a vibration spectrum is depicted which corresponds to a pump having the faulty balls of its bearing. Therefore, additional oscillations are identifiable to the right of the aforementioned characteristic curve, in comparison to the spectrum on the top left.

The vibration spectrum depicted on the bottom left corresponds to a fault of the inner bearing ring, wherein the vibration spectrum depicted on the bottom right corresponds to a fault of the outer bearing ring. A higher hazard level is assigned to the two spectra depicted on the bottom than to a fault which results in the spectrum on the top right.

1-13. (canceled)

14. An electrical device for connection to a high-voltage supply system, the electrical device comprising:
a fluid-tight tank to be filled with an insulating fluid;
a core disposed in said tank and a winding partially enclosing said core;
a cooling unit connected to said tank;
a pump for circulating the insulating fluid of said tank through said cooling unit;
a measuring sensor for detecting vibrations of said pump and providing time-triggered vibration measured values; and
a protection unit connected to said measuring sensor and configured for receiving and converting the time-triggered vibration measured values into frequency-triggered vibration values, said protection unit analyzing the frequency-triggered vibration values for an existence of a fault criterion by using previously determined logic, and said protection unit configured to generate a warning signal upon determining a fault criterion.

15. The electrical device according to claim 14, which further comprises a display unit connected to said protection unit.

16. The electrical device according to claim 14, wherein said measuring sensor is an acceleration sensor attached to said pump.

17. The electrical device according to claim 16, wherein said measuring sensor is a piezo element.

18. The electrical device according to claim 14, wherein the electrical device is a railway transformer.

19. A method for detecting a fault of a component of an electrical device, the method comprising the following steps:
detecting vibrations of the component to be monitored while obtaining time-triggered vibration measured values;
transmitting the time-triggered vibration measured values to a protection unit of the electrical device;
using the protection unit to convert the time-triggered vibration measured values into frequency-triggered vibration values;
using the protection unit to analyze the frequency-triggered vibration values for an existence of a fault criterion by using logic; and
using the protection unit to trigger a warning signal upon an existence of a fault criterion.

20. The method according to claim 19, which further comprises:
transmitting the time-triggered vibration measured values or the frequency-triggered vibration values over a wireless connection to a cloud server;
using the cloud server, in addition to an evaluation unit, to check received data for an existence of a fault criterion by using a previously known logic; and
generating a cloud warning signal upon an existence of a fault criterion.

21. The method according to claim 20, which further comprises transmitting the cloud warning signal back to the protection unit.

22. The method according to claim 19, which further comprises analyzing the frequency-triggered vibration values for an existence of a plurality of fault criteria being respectively associated with a particular hazard level.

23. The method according to claim 19, which further comprises transmitting the warning signal to a display unit configured for an optical depiction of a respective fault.

24. The method according to claim 19, which further comprises using a filter unit to filter the frequency-triggered vibration values and to suppress vibration values of predetermined frequency ranges.

25. The method according to claim 19, which further comprises providing a pump as the component.

26. The method according to claim 19, which further comprises providing a railway transformer as the electrical device.
